(19) United States
(12) Patent Application Publication
(10) Pub. No.: US 2015/0347955 A1
(43) Pub. Date: Dec. 3, 2015

(54) MANAGING STAFFING REQUIREMENTS

(71) Applicant: Vivint, Inc., Provo, UT (US)

(72) Inventor: Greg Fairbanks, Cedar Hills, UT (US)

(73) Assignee: Vivint, Inc., Provo, UT (US)

(21) Appl. No.: 14/291,748

(22) Filed: May 30, 2014

(51) Int. Cl. G06Q 10/06; H04W 4/02

(52) U.S. Cl. CPC G06Q 10/063116; H04W 4/02

(57) ABSTRACT

A computer-implemented method to manage staffing requirements is disclosed. The method may comprise creating a network of employees. The method may also determine if a staffing level from the network of employees satisfies a threshold and may also poll one or more employees from the network of employees based in at least in part on the determining step. In some embodiments, the method may predict a potential staffing shortage. Predicting the staffing shortage may include identifying a physical location of a scheduled employee prior to a scheduled shift and determining the identified physical location of the scheduled employee is greater than a distance threshold.

### BACKGROUND

Advancements in media delivery systems and media-related technologies continue to increase at a rapid pace. Increasing demand for media has influenced the advances made to media-related technologies. Computer systems have increasingly become an integral part of the media-related technologies. Computer systems may be used to carry out several media-related functions. The wide-spread access to media has been accelerated by the increased use of computer networks, including the Internet and cloud networking.

Many homes and businesses use one or more computer networks to generate, deliver, and receive data and information between the various computers connected to the computer networks. Users of computer technologies continue to demand increased access to information and an increase in the efficiency of these technologies. Improving the efficiency of computer technologies is desirable to those who use and rely on computers.

With the wide-spread use of computers and mobile devices has come an increased presence of technology in everyday life. Advancements in mobile devices and related mobile technology allow users to monitor their location, movement, and/or other aspects of everyday life. As technology expands into homes and businesses, opportunities exist for using technology for alternative purposes such as tasks related to a business and staff management.

### SUMMARY

According to at least one embodiment, a computer-implemented method to manage staffing requirements is disclosed. The method may comprise creating a network of employees. The method may also determine if a staffing level from the network of employees satisfies a threshold and may also poll one or more employees from the network of employees based in at least in part on the determining step. In some embodiments, the method may predict a potential staffing shortage. Predicting the staffing shortage may include identifying a physical location of a scheduled employee prior to a scheduled shift and determining the identified physical location of the scheduled employee is greater than a distance threshold.

In some embodiments, creating the network of employees may comprise registering a Global Positioning System (GPS) enabled device associated with each employee of the network of employees. It may also include adding the GPS-enabled device to a network associated with an employer. The GPS-enabled device may comprise a profile including available work times, primary job duties, and secondary job duties. In some embodiments, determining if a staffing level satisfies a threshold may occur on a regularly scheduled basis. The regularly scheduled basis occurs on an hourly basis.

In some embodiments, the method may determine a necessary staffing level requirement, wherein the requirement consists of a combination of a number of employees and a job function of the employees. In alternative embodiments, determining if the staffing level satisfies the threshold may comprise comparing the staffing level to a necessary staffing level requirement to determine if the staffing level is satisfied. The staffing level may be based at least in part on a number of employees and job functions of the employees.

In alternative embodiments, polling the one or more employees may comprise identifying a first employee, sending a message to a GPS-enabled device associated with the first employee, and receiving a response from the first employee. Identifying the first employee may comprise identifying a current location of the first employee and identifying one or more primary job duties or secondary job duties associated with the first employee. In some embodiments, upon receiving a negative response from the first employee, the method may comprise identifying a second employee and sending a message to the second employee. Identifying the second employee may be based at least in part on a current location of the second employee and one or more primary job duties or secondary job duties of the second employee. In some embodiments, a negative response may comprise a non-receipt of a response within a predetermined time period.

According to another embodiment, an apparatus for managing staffing requirements is also described. The apparatus may include a processor, a memory in electronic communication with the processor and instructions stored on the memory of the processor. The processor may execute the instructions to create a network of employees, determine if a staffing level from the network of employees satisfies a threshold, and poll one or more employees from the network of employees based at least in part on the determine step.

According to another embodiment, a computer-program product for managing staffing requirements is also disclosed. The computer-program product may include a non-transitory computer-readable medium that may store instructions executable by a processor. The instructions may create a network of employees, determine if a staffing level from the network of employees satisfies a threshold, and poll one or more employees from the network of employees based at least in part on the determine step.

The foregoing has outlined rather broadly the features and technical advantages of examples according to the disclosure such that the following detailed description may be better understood. Additional features and advantages will be described hereinafter. The conception and specific examples disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the embodiments may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram of an environment in which the present systems and methods may be implemented;

FIG. 2 is a block diagram of an example of another environment in which the present systems and methods may be implemented;

FIG. 3 is a block diagram of an example staff management module of the environment shown in FIGS. 1 & 2;

FIG. 4 is a block diagram of an example staffing module of the environment shown in FIG. 3;

FIG. 5 flow diagram illustrating a method of managing staffing requirements;

FIG. 6 is a flow diagram illustrating another method of managing staffing requirements;

FIG. 7 a block diagram of a computer system suitable for implementing the present systems and methods of FIGS. 1-6;

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

The systems and methods described herein relate to managing staffing requirements. More specifically, the systems and methods described herein relate to an automated system for tracking the location of employees and polling employees when necessary to ensure adequate staffing levels. In one example, a mobile device associated with an employee may allow tracking a location of the employee. In some cases, this information may be used to poll other employees to fill when a staffing shortage is predicted or present.

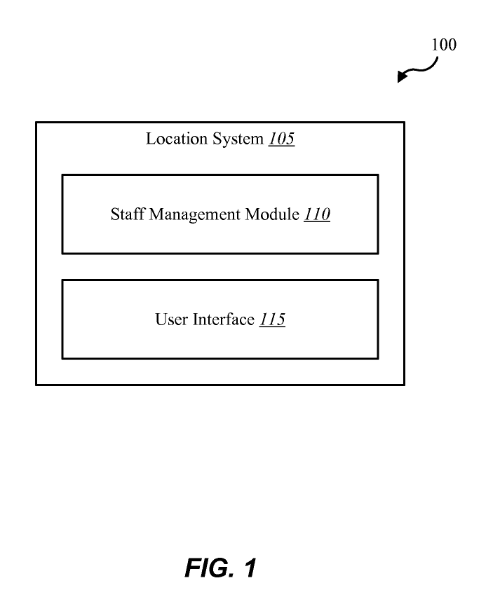

FIG. 1 is a block diagram illustrating one environment 100 on which the methods and disclosure may be implemented. The environment 100 may include a location system 105. The location system 105 may include a staff management module 110 and a user interface 115. While FIG. 1 shows the staff management module 110 and the user interface 115 included within the location system 105, these and other components of the environment 100 may be housed separately and operate independently while still working cooperatively with each other and other components of the location system 105.

The location system 105 may be associated with a commercial entity. For example, the location system 105 may be located at a business. The business may be any commercial business. In some instances, the business may be a restaurant, a retailer, a warehouse, a health-care provider, and the like. In some instances, a location system 105 may be present at multiple different locations associated with the same business. For example, the business may be part of chain, may have satellite offices, or the like. In other examples, the business may have multifunctional locations. For example, a business may have a warehouse, a manufacturing facility, an office space, a testing space and/or any combination. In those embodiments, the environment 100 may have multiple location systems 105 for each business location. In other embodiments, one location system 105 may be present at one location and may service all of the business's locations. When the term business is used herein, it encompasses all types of non-residential locations.

The location system 105 may be controlled by an administrator. The administrator may be a supervisor, business owner, CEO, employee, or some other professional. In some embodiments, multiple people might be the administrator. For purposes of clarity, the term administrator used herein may encompass either a single individual or multiple individuals with equal access to the location system 105.

The staff management module 110 may be configured to track a location of an employee, regardless of whether they are currently scheduled to work or not. For purposes of clarity, employee will be used throughout the specification but may refer to multiple employees. In some embodiments, the staff management module 110 may be a mostly passive tracking system requiring little to no user input. In other embodiments, the staff management module 110 may be a combination active/passive system or a mostly active system. The user interface 115 may interact with the staff management module 110 and receive active tracking information such as employee location, employee work schedule, employee primary and secondary duties, and/or proximity to a work location. In some embodiments, the user interface 115 may be associated with a staffing management system onsite at a business. In other embodiments, the user interface 115 may be integrated with the employee's device.

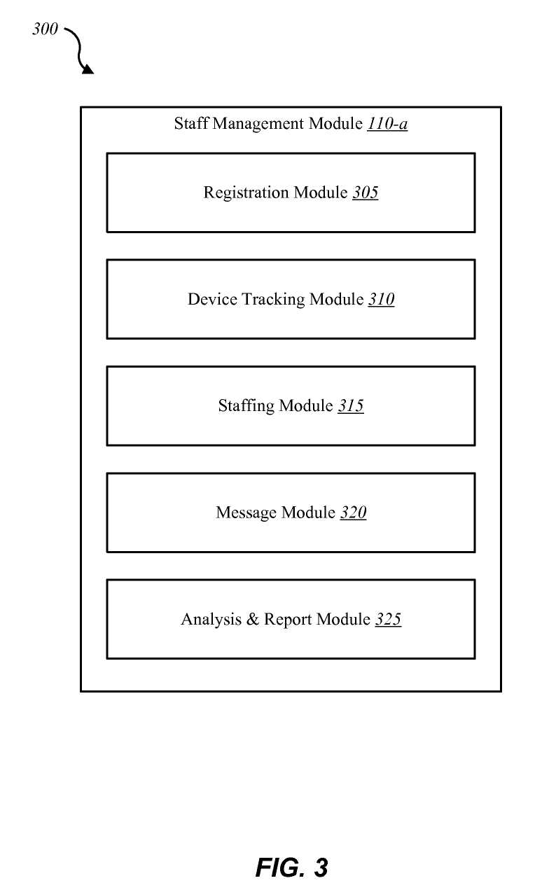

The staff management module 110 may, in addition to receiving employee work profile and device data, have the capability to store the data, analyze the data, create notifications related to the data, store criteria against which the data is evaluated, and other functions as described in further detail below with reference to FIG. 3. The staff management module 110 may include the capability to confirm identification of an employee using any of a variety of identification verification techniques. The staff management module 110 may also be capable of receiving communications from a remote device in response to or separate from the employee work and device data. The staff management module 110 may perform additional functions in response to instructions received from a remote source.

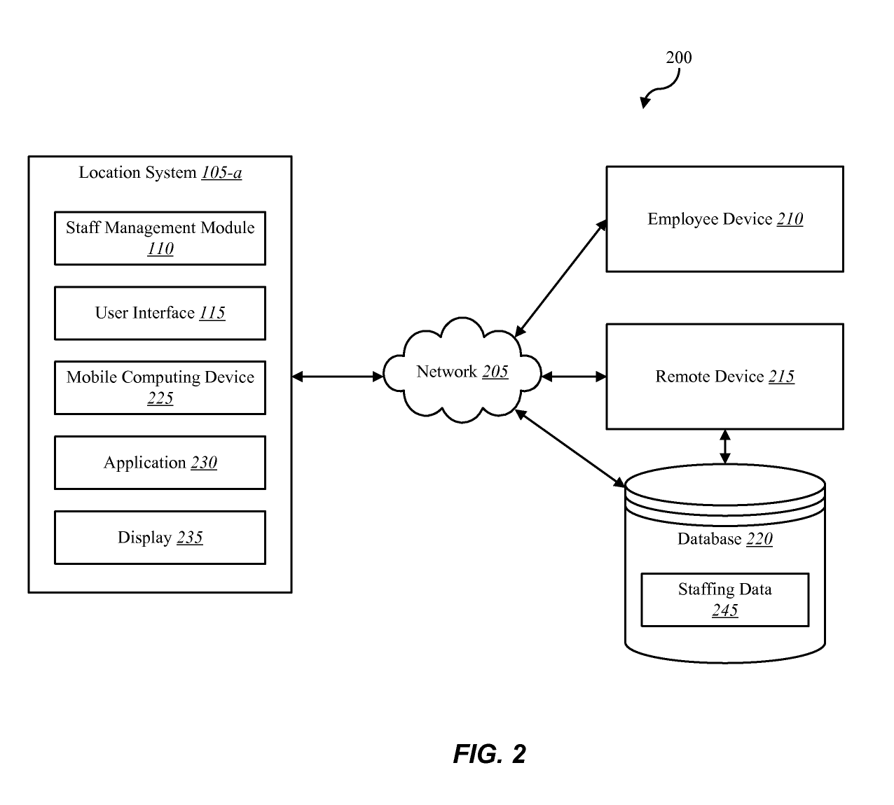

Referring now to FIG. 2, in some embodiments, an environment 200 may include the components of environment 100 described above, and may further include a network 205, an employee device 210, a remote device 215, and a database 220. The location system 105-a may be one example of the location system 105 described above with reference to FIG. 1. The location system 105-a may include, in addition to the staff management module 110 and the user interface 115, a mobile computing device 225, an application 230, and a display 235. A database 220 may include (e.g., store) staffing data 245.

The location system 105-a may include various components and functionalities that work cooperatively with the staff management module 110 and the user interface 115, and/or may operate independently of the staff management module 110 and the user interface 115. In some embodiments, the application 230 may use the location system 105-a to perform tasks related to the staff management module 110.

In some embodiments, the mobile computing device 225 may include one or more processors, one or more memory devices, and/or a storage device. Examples of the mobile computing device 225 may include mobile computing devices, smartphones, personal computing devices, computers, servers, etc. The mobile computing device 225 may be operable independent of features of the staff management module 110 and the user interface 115. Alternatively, at least some functionality of the mobile computing device 225 may cooperate with and/or interface with the staff management module 110 and/or the user interface 115.

The application 230 may allow a user or administrator to control (either directly or indirectly) an aspect of the property where the location system 105-a is located. In some configurations, the application 230 may also interface between, for example, the staff management module 110, the user interface 115, the mobile computing device 225, or the display 235. Thus, the application 230, via the user interface 115, the display 235, and/or the mobile computing device 225, may allow users to monitor a location of the employees even if the employees are not at the work location. Information or data associated with the application 230 and its operation may be saved according to the data storage methods described herein.

In some embodiments, a user may access the functions of the location system 105-a from the mobile computing device 225. For example, in some embodiments, the mobile computing device 225 includes a mobile application that interfaces with one or more functions of the location system 105-a (e.g., staff management module 110). Examples of the mobile computing device 225 may include a personal computing device (e.g., a laptop, desktop, etc.), a mobile computing device (e.g., tablet computing device, smartphone, etc.), and the like. The staff management module 110 and/or the user interface 115 may be integrated with the mobile computing device 225 in the form of one or more personal computing devices (e.g., mobile devices, smartphones, and/or personal computing devices) to control aspects of the location and/or monitor activities of an employee (e.g., clock-in, clock-out, perform duties, job performance, etc.).

In some embodiments, the employee device 210 may be a mobile device unique to an employee. The employee device 210 may include, for example, a personal computing device (e.g., laptop), a mobile computing device (e.g., tablet computing device, smartphone, etc.), a wearable device, a multi-purpose portable device, a multi-purpose pocket computer, or the like. The employee device 210 may be in communication with the staff management module 110 or other features or components of the location system 105-a via, for example, the network 205. The employee device 210 may be capable of two-way communication with the staff management module 110 and other features of the location system 105-a including, for example, receiving notifications from and sending information (e.g., notifications, time entry information, etc.) back to the staff management module 110 or other features of the location system 105-a. The employee device 210 may include a display and/or user interface. Notifications may be received on the employee device 210 in the form of, for example, a text message, email, audible signal, picture, ping message, etc. The notifications received at the employee device 210 may be in response to staffing data which is collected and/or generated via the staff management module 110 and/or the user interface 115 and delivered to the remote device 215 and/or the database 220, or directly to the employee device 210. The employee device 210 may also include storage capability to store data such as employee work data, employee movement, notifications, schedules, contact information, and the like associated with their employment.

The remote device 215 may also communicate with the staff management module 110 and other features and components of the location system 105-a via, for example, the network 205. The remote device 215 may be any of a number of electronic devices including, for example, a dedicated automation computing device (e.g., wall-mounted controller), a personal computing device (e.g., laptop, desktop, etc.), a mobile computing device (e.g., a tablet computing device, smartphone, etc.), and the like. The remote device 215 may be located physically away from the location system 105-a or components thereof such as, for example, the user interface 115. The remote device 215 may be accessed by, for example, an owner of the place of business, manager, supervisor, or other personnel associated with the place of business where the employee is employed. The remote device 215 may be configured for two-way communication with the staff management module 110 and other features of the location system 105-a. The remote device 215 may receive notifications and information associated with an employee (e.g., employee location or staffing data). The staffing data 245 may be accessed directly from the database 220, from the employee device 210 via, for example, the network 205 and/or the staff management module 110, or other components of the location system 105-a. The staffing data 245 may be in the form of raw data such as, for example, staffing requirements which may include staffing levels for specific days, hours, weekends, seasonal times. The raw data may also include staffing profiles. For example, each employee may have a staffing profile which may include primary and secondary duties. The staffing data 245 may also include more detailed information. For example, it may include staffing schedules and may record locations of employees when employees have left the work location. For example, some commercial entities may incorporate a delivery service. The staffing data 245 may record the location and times for the deliveries. The staffing data 245 may also include information regarding when employees voluntarily filled in for staffing shortages and create preferred profiles for such employees.

The remote device 215 may include a user interface, storage capability, and other features and functionalities that permit the remote device 215 to not only receive notifications and data, but to also send instructions, data, notifications, and the like. The remote device 215 may receive employee work and device data, analyze the data, store the analyzed data (e.g., in database 220), and send notifications to the employee device 210, the staff management module 110, or other components of the location system 105-a, or to another location or remote device 215.

The network 205 provides communication via, for example, wired or wireless connections. Further, the network 205 may include a plurality of communication mediums. For example, the network 205 may include different communication mediums to provide communication between the staff management module 110 and/or other components of the location system 105-a and other devices such as the employee device 210, the remote device 215, and the database 220. Examples of the network 205 may include cloud networks, local area networks (LAN), wide area networks (WAN), virtual private networks (VPN), wireless networks (using 802.11, for example) and/or cellular networks (using 3G and/or LTE, for example), etc. In some embodiments, the network 205 may include the internet.

FIG. 3 is a block diagram 300 illustrating one example of the staff management module 110-a. The staff management module 110-a may be one example of the staff management module 110 depicted in FIGS. 1 and/or 2. As depicted, the staff management module 110-a may include a registration module 305, a device tracking module 310, a staffing module 315, a message module 320, and an analysis & report module 325. Other embodiments may include additional or, in some embodiments, less modules than that which is shown in FIG. 3.

In some embodiments, the registration module 305 may identify and link one or more employees to the staff management module 110-a. For example, the registration module 305 may receive input that a new employee needs to be added to the system. The input may come from an administrator of a business. The input may contain a request. The request may contain information such as a name of the employee, an employee number, contact information associated with an employee, a mobile device identifier, or the like. The employee number may be a unique identifier that represents the employee in the business's system. The contact information may be an email address, mobile phone address, social media contact, etc.

The mobile device identifier may be a variety of identifiers that uniquely identify a mobile device. For example, the mobile device identifier may be a serial number of a device, a Bluetooth address, a Wi-Fi address, an international mobile station equipment identity (IMEI) number, an integrated circuit card identifier (ICCID), a mobile equipment identifier (MEID), or any other unique mobile device identifier. In some embodiments, the employer may submit the unique device identifier when adding the employee to the system. In other embodiments, the registration module 305 may pull the information from the mobile device. For example, if the employee is emailed a link, the link may be accessed on the mobile device and provide information back to the registration module 305. The registration module 305 may then create a unique employee profile containing a unique mobile device identifier.

In some embodiments, the registration module 305 may require the employee to download an application onto their mobile device. For example, the employee may access an application “store” from their device. From the application store, the employee may download an application associated with the employer, or associated with a service provider used by the employer. The mobile application may be installed directly on the device and may allow the registration module 305 to uniquely identify and track the device. In some embodiments, the application may be a passive application and run in the background on the user's mobile device. In other embodiments, the application may be an active application and require, allow, and/or enable interactions with the employee.

The device tracking module 310 may determine a location of a GPS-enabled device associated with the employee. For example, the device tracking module 310 may determine a proximity of the employee to the business based upon a location of the device associated with the employee. The device tracking module 310 may determine the location of an employee at set intervals or upon certain events. For example, the device tracking module 310 may determine and, in some instances, record a location of an employee at regularly scheduled intervals such as approximately every two hours. In other embodiments, the device tracking module 310 may determine a location of an employee prior to a scheduled shift, or to locate replacement staff.

In some embodiments, the device tracking module 310 may determine a distance between an employee and the business. For example, the device tracking module may determine an employee is a number of miles from the business or within an ascertainable driving distance. In other embodiments, the device tracking module 310 may locate all employees within a set proximity of the business. For example, the device tracking module 310 may be able to locate all employees within approximately five miles of the business.

In other embodiments, the device tracking module 310 may determine movement of the employee. For example, the device tracking module 310 may determine an employee is en route to the business by determining movement of the device. Further, the device tracking module 310 may determine the employee is at home or is at a location performing job duties. For example, the employee may be hospice personnel and the device tracking module 310 may determine the personnel is at a residential location where the employee is scheduled to work.

In some embodiments, the device tracking module 310 may determine an employee will be late to their shift. For example, the device tracking module 310 may determine the employee is en route but will be late due to traffic. In other embodiments, the device tracking module 310 may determine the employee is too far away from the business to be on time. For example, the employee may be thirty miles away and their shift might start in ten minutes. Or conversely, due to traffic and speed regulations, the employee is over an hour drive away from the business and their shift starts in half an hour.

In some embodiments, the device tracking module 310 may track a proximity of the employee to the business at a predetermined time before their shift. The device tracking module 310 may determine a time that it will take the employee to travel to work and may remind the employee to begin their trip to work in order to start their shift on time. For example, the device tracking module 310 may determine a location of employees approximately 2 hours before their shift. The device tracking module 310 may determine a time it will take the employee to arrive at work. Using that information, the device tracking module 310 may determine a time when the employee must leave to arrive to work in a timely fashion. The device tracking module 310 may then alert the employee to leave before that time. For example, at the two-hour mark, the device tracking module 310 may determine the employee is thirty minutes from work. Then, forty-five minutes prior to their shift starting, the device tracking module 310 may alert the employee to leave within the next fifteen minutes to arrive on time. In some embodiments, the employee may respond to the alert. In the response, the employee may confirm attendance, call-in sick, or alert the business that they will be late.

If the device tracking module 310 knows the employee will be late or absent, the device tracking module 310 may work in conjunction with other modules in the staff management module 110-a to determine replacement, backup, or alternative staff. For example, the device tracking module 310 may determine a proximity of potential replacement staff (which may be available using the replacement module 420 discussed below). The device tracking module 310 may determine the closest replacement employee. The device tracking module 310 (or in some embodiments, another module in the staff management module 110-a) may message the employee asking the employee to work. Depending upon the response, the device tracking module 310 may continue locating replacement staff until replacement staff is confirmed.

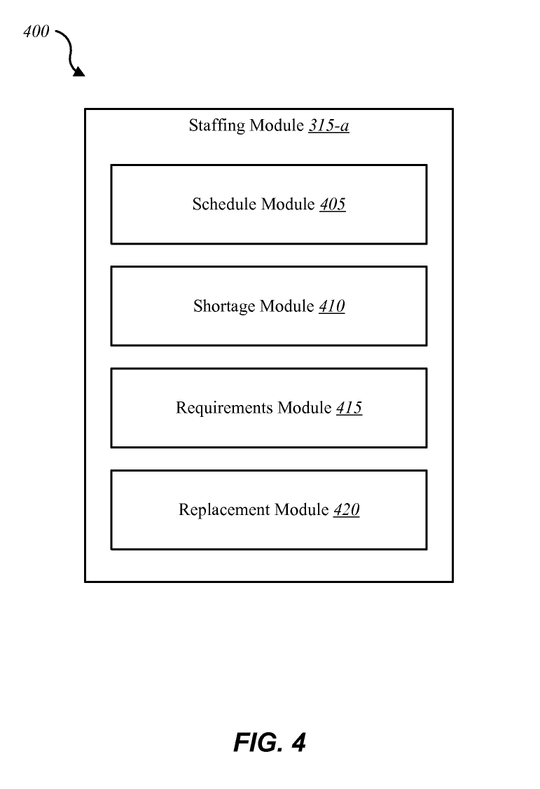

FIG. 4 is a block diagram 400 illustrating one example of a staffing module 315-a. The staffing module 315-a may be one example of the staffing module 315 displayed in FIG. 3. As depicted, the staffing module 315-a may include a schedule module 405, a shortage module 410, a requirements module 415 and a replacement module 420. Other embodiments may include additional or fewer capabilities than those illustrated in FIG. 4.

The schedule module 405 may be configured to storage, manage, and/or track the employees schedule. The schedule module 405 may include an input mechanism allowing an administrator or employee to enter in scheduling information. The scheduling information may include times an employee is scheduled to work, the job duties, and the like. In some instances, the schedule may include backup information. For example, if an employee is absent, the schedule may list replacement employees to replace the scheduled employee. In some instances, the replacement employee may be chosen from a list of qualified employees or employees with similar capabilities and/or job duties. In other embodiments, the schedule module 405 may allow employees to sign up for replacement shifts. In further embodiments, the employee may enter available times. The schedule module 405 may gather and analyze the information and may, in some embodiments, generate a schedule for the business. If an employee was available but not scheduled, the employee may be listed as a replacement employee for the shift. In other embodiments, the schedule module 405 may poll employees to volunteer as backup if a staff shortage is present.

The shortage module 410 may determine if there is a current or potential staffing shortage at a business. In some embodiments, the shortage module 410 may determine which employees are working. The shortage module 410 may compare the working employees with the scheduled employees. For example, when an employee arrives to work, they may clock-in manually to a system or their mobile device may be detected by an automated time and attendance module. For example, when the employee's mobile device connects to the wifi, the unique identifier may register with the system and may clock-in the employee. Similarly, the employee may clock-in using more traditional methods. The shortage module 410 may compare all of the employees that have clocked-in, either manually or automatically, and compare the current level of employees to a scheduled number of employees. Based on the comparison, the shortage module 410 may determine the shift will be short staffed and may send an alert to the administrator or attempt to find a replacement employee.

In other embodiments, the shortage module 410 may determine a location of the employee to determine if a staffing shortage may occur. For example, the shortage module 410 may receive employee location information from, for example, the device tracking module 310 (See FIG. 3). The shortage module 410 may use the location information to determine the proximity of the employee to the business will cause the employee to be late. In some embodiments, the shortage module 410 may determine that the tardiness of the employee will have a negligible effect on the business. For example, the employee may be approximately five or ten minutes or in some embodiments may be an hour late. The shortage module 410 may determine that the business will not be negatively impacted by the tardiness of the employee.

In some embodiments, once the shortage module 410 receives location information regarding a location of the employee, the shortage module 410 may cause a message to be sent to the employee. The message may remind the employee of their pending shift. In some embodiments, the message may alert the employee that a replacement employee will replace them unless a confirmation is received from the employee. In other embodiments, the employee may alert the shortage module 410 that they will be absent. For example, the employee may be in traffic en route and will be late, the employee may have an emergency that prevents them from working, or other extenuating circumstances where the employee will be unable to fulfill their duties.

In some embodiments, the job function relating to the employee may take the employee away from the business location. For example, the employee may be required to make deliveries, or to go to different location and perform duties. For example, the employee may deliver packages, food, or other goods. In other examples, the employee may be a dog walker, cleaning personnel, hospice care, or another service based job function requiring the employee to travel and perform duties at an off-site location. In those embodiments, the shortage module 410 may determine the employee has encountered some unforeseen difficulties and may not make their next appointment, delivery or otherwise be unable to perform their job duties. The shortage module 410 may find replacement staff necessary and relay this information to the replacement module 420 (discussed below).

The requirements module 415 may determine the staffing needs in terms of staffing for the business location. The staffing needs may incorporate a plethora of information. For example, the staffing needs may relate to job functions, time, day, season, etc. The requirements module 415 may store requirements set by an administrator. The requirements may include a specific number of staff for each job function. For example, the administrator of a restaurant may set requirements for a hostess, wait staff, bar staff, cook line, kitchen, among other functions in the food industry. The requirements may differ depending on day of the week, time of day, and season. For example, a coffee shop may not have the same staffing requirements in the evening as it does in the morning. Staffing needs may also differ in the summer, winter, fall, holiday season. Staffing needs may further differ based on day of the week. For example, during the week, the coffee shop may be busiest in the early morning but on the weekends it may be busier during brunch hours. The administrator may be able to set their desired requirements for all of these times and factors. Similarly, other businesses may see a differentiation in staffing needs that may be set by an administrator.

In other embodiments, the requirements module 415 may contain a learning algorithm and to set staffing needs. For example, the requirements module 415 may determine the staffing needs based on feedback from an administrator, employee and/or the like. For example, the requirements module 415 may poll the parties after a shift ended and ask for feedback on the staffing levels, among other things. The requirements module 415 may use all the information, record it, and determine the proper staffing levels for each job function.

In other embodiments, the requirements module 415 may also receive business information. For example, in a restaurant, the requirements module 415 may receive information such as number of parties for dinner, size of parties, all of the orders entered into the system, when the party arrived and was seated and when the party left, and the like. The requirements module 415 may analyze all of this information and overtime, develop staffing levels that align with the patterns of the business. In further embodiments, when the customer receives a receipt, the receipt may contain a survey where the customer can enter in feedback. For example, a receipt from a home improvement store may have a link to a survey and the customer may take the survey. The survey may ask questions relating to the staffing level. For example, the survey may ask if the customer had any difficulty finding help, getting questions answered, if their checkout wait was excessive, and the like. The requirements module 415 may combine the customer feedback with purchase information to additionally improve the scheduling requirements.

The replacement module 420 may locate and confirm a replacement employee. For example, the replacement module 420 may determine the business is short-staffed and determine the type of necessary replacement staff. The replacement module 420 may determine the parameters of the replacement staff. For example, the replacement module 420 may locate the closest employee to fill in because the staffing need is urgent. In other embodiments, the replacement module 420 may require a person with specific skills to fill in. For example, a hospice nurse may be absent. The client may have special needs only fulfilled by specific staff members. The replacement module 420 may then only find a replacement staff from the specific list of people. In other embodiments, the business may require specific skills and may poll employees only with those skills.

Returning back to FIG. 3, the message module 320 may facilitate the messages between the device tracking module 310 and the employee. For example, the message module 320 may send a message to the employee when one of the thresholds are met in the device tracking module 310. In some embodiments, the message may be sent as one of an SMS message, email, ping message, phone call or the like. In some embodiments, the message module 320 may facilitate communication with the employee using an application the employee downloaded to their mobile device.

In other embodiments, the message module 320 may facilitate the messages between employees and the location. For example, the message module 320 may work in conjunction with the other modules in the staff management module 110-a to generate, send and receive messages. Some examples of the messages were discussed above. For example, the staff management module 110-a may send a message to an employee reminding them of their upcoming shift, another message may remind the employee to leave within a certain time frame to arrive to work on time. The message module 320 may also receive messages from the employee. In those embodiments, the message module 320 may work with the other modules to send messages to potential replacement employees.

In some embodiments, the message module 320 may also send messages to shift supervisors concerning the activity. For example, the shift supervisor may receive a message that an employee will be tardy or absent. In some embodiments, the staff management module 110-a may automatically find a replacement. In some embodiments, the message module 320 alert a supervisor that replacement staff is being located. In still other embodiments, a message may request supervisor approval prior to locating replacement staff. Sometimes, replacement staff may be unnecessary and the supervisor may elect not to find replacements. In other embodiments, replacement staff may be necessary and the supervisor may affirmatively respond requesting replacement staff.

In further embodiments, the staff management module 110-a may determine the business is extraordinarily busy. For example, the staff management module 110-a may track business records in real time and determine an unnatural flux in business. In those instances, the message module 320 may ask the supervisor if additional staff is necessary. The supervisor may respond affirmatively requesting additional staff. The supervisor may request staff to arrive within a desired time frame and may specify job functions. For example, a restaurant may have had an unexpected arrival of a multitude of guests. The restaurant may need additional cooks and wait staff to handle the unexpected business. The supervisor may relay the information to the staff management module 110-a which may locate appropriate staff.

In some embodiments, the analysis & report module 325 may analyze the data gathered by the staff management module 110-a and generate various reports. The reports may be historical or forecasting reports. For example, the historical reports may analyze and list the predicted staffing requirements, actual staffing requirements, business profit, staff attendance, when replacement or additional staff was necessary and the like. In some embodiments, the analysis & report module 325 may also generate forecasting reports. For example, the analysis & report module 325 may generate an upcoming schedule, historical information relating to the time period, attendance performance of scheduled staff and the like. The historical information relating to the time period may be the activity and actions that occurred during that time period the previous year, five years, or decade. For example, the analysis & report module 325 may generate a report for Easter weekend. The report may include a list of scheduled employees, previous business records from Easter weekend in prior years, and potential replacement staff. The analysis and reports may aid a supervisor in ensuring sufficient staffing levels and business needs are met.

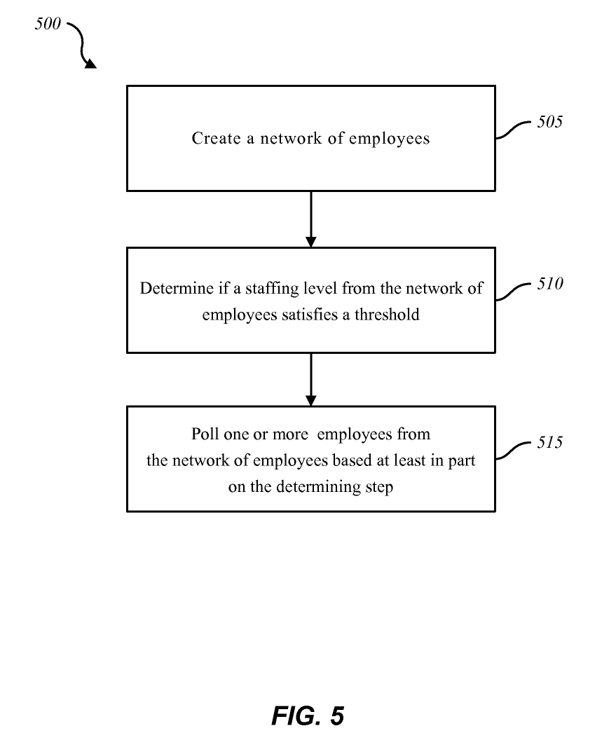

FIG. 5 is a flow diagram illustrating one embodiment of a method to manage staffing. In some configurations, the method 500 may be implemented by the staff management module 110 of the location system 105 shown in FIGS. 1 and/or 2. In other examples, the method 500 may be performed generally by the location system 105 shown in FIGS. 1 and/or 2, or even more generally by the environments 100, 200 shown in FIGS. 1 and/or 2.

At block 505, a network of employees may be created. For example, business may wish to track a device associated with an employee. The employer may add the employee to a network. The network may be associated with the business. The employee may then, receive via their mobile device, a request to join the network. The request may gather specific information such as a unique identifier to correctly identify the device.

At block 510, it may be determined whether threshold of staffing level from the network of employees is satisfied. For example, the business may require a set number of employees to be adequately staffed. The predetermined number of employees may vary based on time, day, season and the like. In some instances, each job function may have a predetermined number of employees. For example, at a retail location, there may be a predetermined number of employees to aid customers on the retail floor, employees to work the cashiers and employees to keep the supplies stocked and orderly. Depending upon the type of business, the number of employees and job duties of the employee will vary. The predetermined number of employees and job duties may be compared to the actual number of employees working. In some instances, the business may be under- or over-staffed.

If the business is understaffed, at block 515, one or more employees from the network may be polled based at least in part on the determining step at block 510. For example, the business may need extra staff due to a scheduling error, an employee not showing up, or the like. The polling may include determining which employees are within a predetermined proximity of the business. The employees may be required to have certain primary or secondary job skills. In some embodiments, the polling may include sending a message to the nearest employee with adequate job duties to determine their availability. If a negative response is received, the polling may continue until replacement or additional staff is confirmed.

Other steps of method 500 may include requiring the employee to download an application to their mobile device, sending reminders of upcoming shifts to employees, sending alerts to supervisors if an employee misses a shift, reminding the employee to charge their mobile device if the battery is low, scheduling employees, and analyzing the data collected to generate a variety of reports.

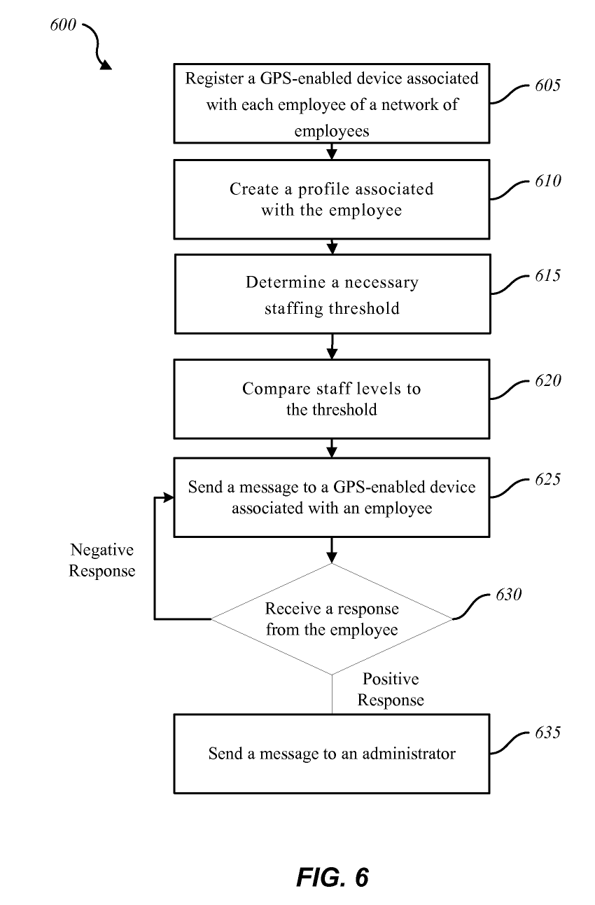

FIG. 6 is a flow diagram illustrating an embodiment of another method 600 for managing staff. In some configurations, the method 600 may be implemented by the staff management module 110 of the location system 105 shown in FIGS. 1 and/or 2. In other examples, the method 600 may be performed generally by the location system 105 shown in FIGS. 1 and/or 2. Even still more generally, the method 600 may be performed generally by the environments 100, 200 shown in FIGS. 1 and/or 2.

At block 605, a GPS-enabled device is registered. The GPS-enabled device may be associated with an employee. The employee may be associated with a network of employees. Registering the device may include sending a message to the device. In some instances, the message may be one of an SMS message, email, voice message, or the like. The message may contain information directing the employee to register for their device. Registering the device may associate the device with a network of employees associated with a business. Once registered, in some embodiments, the business may track a location of the device. In some embodiments, registering the device may require downloading an application to the device.

At block 610, the employee may create a profile. The profile may be associated with an employee. In some embodiments, the administrator may create the profile for the employee. The profile may contain information relating to the employee's job duties. For example, the profile may contain information relating to the employee's primary job duties. The profile may also contain information about the employee's secondary job duties. For example, a person who works for a retail store may be qualified to work as a cashier or as a floor's sales person. The profile may also contain information such as the employee's availability to work. For example, the employee may fill out information outlining when their availability. The information may be generic or specific to a certain time period. For example, the employee may list availability monthly, weekly, etc. In some embodiments, the profile may contain employee's vacation schedules. In further embodiments, the profile may contain other information such as the employee's contact information, wage information, home address, emergency contact information, and the like.

At block 615, a necessary staffing threshold may be determined. The necessary staffing threshold may be set by an administrator or a staffing module (e.g. staffing module 315). The staffing threshold may be based on time of day, day of the week, month, season, holiday, and the like. The threshold may also be based upon job function of the employees. For example, each job functions may have different staffing requirements.

At block 620, the current staff levels may be compared to the threshold. For example, the number of employees currently scheduled to work and working may be compared to the number of employees scheduled or to a threshold separate from the schedule. It may be determined that the business is short-staffed. For example, a staff may not have arrived to work or may have called in sick. In some instances, an employee may also have gone home sick.

At block 625, a message may be sent to a GPS-enabled device associated with an employee. For example, once a staffing shortage is determined, the method 600 may determine that a replacement employee is necessary. To find a replacement employee, the employees within a predetermined proximity may be located. In some embodiments, it may be the closest employees or, in some instances, it may be all employees. The predetermined proximity of employees located may be determined by the urgency of the staffing requirement. For example, the business may be short-staffed but may not need replacement staff until a later time frame (e.g. a restaurant might not need an additional cook until the dinner rush). In other instances, the staff need may be immediate and the business may need replacement or alternative employees to arrive as quickly as possible to help with the staffing shortage. The message sent to the employee may ask if the employee is available to work. It may include information such as a time the employee needs to arrive, when the shift would end, if the employee would receive any overtime or bonus pay and the like.

At block 630, a response from the employee may be received. In some embodiments, a positive response may indicate the employee is able to work and meet the requirements. If a positive response is received, the method may continue to block 635. At block 635, a message may be sent to an administrator. The message may include information such as which employee did not show up to work, if there was an unexpected event that caused an increase in business, or the like. The message may further include information such as which employee is filling in, if certain pay incentives were given, and the like.

In some embodiments, a response may not be received. If a response is not received within a predetermined time period, it may be assumed to be a negative response. For example, if a response is not received within approximately ten minutes, it may be deemed a negative response from the employee. The time period may be five minutes, ten minutes, or as long as one hour. The predetermined time period may depend upon the urgency of the staffing needs and may vary. If a negative response is received or a lack of response is determined, the method may continue back to block 625.

In some embodiments, other steps of method 600 may include portions of the method 500. In other embodiments, the method of 600 may include finding the closest replacement employee, asking an administrator if replacement staff is necessary, receiving a notification from the employee that they cannot work that day, registering multiple employees, share employee networks with other businesses that are a part of a network (e.g. a chain commercial business), and the like.

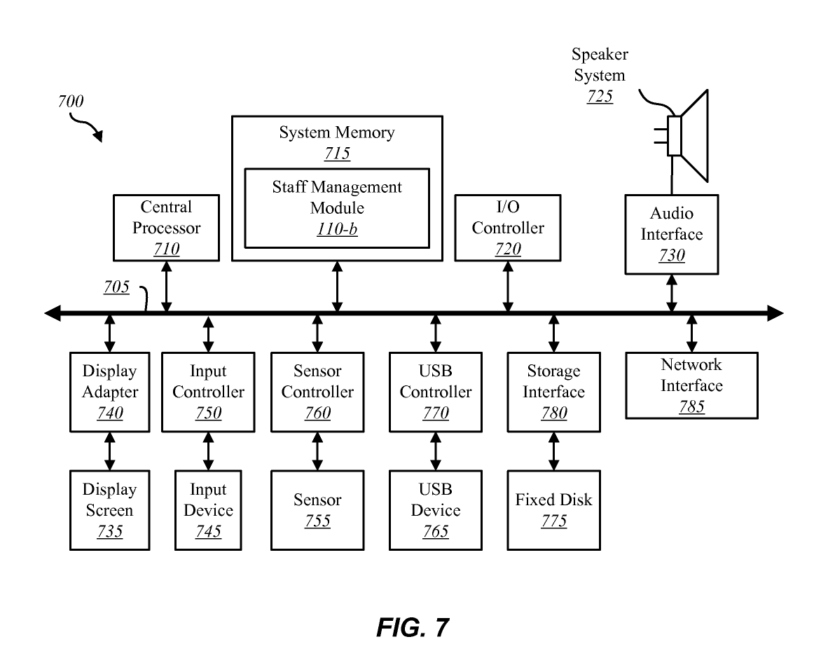

FIG. 7 depicts a block diagram of a computer system 700 suitable for implementing the present systems and methods. The computer system 700 may be an example of the mobile computing device 225, the remote device 215, the employee device 210, the database 220, and/or some combination thereof illustrated in FIG. 2. In one configuration, the computer system 700 may include a bus 705 which interconnects major subsystems of the computer system 700, such as a central processor 710, a system memory 715 (typically RAM, but which may also include ROM, flash RAM, or the like), an input/output controller 720, an external audio device, such as a speaker system 725 via an audio output interface 730, an external device, such as a display screen 735 via display adapter 740, an input device 745 (e.g., remote control device interfaced with an input controller 750), multiple USB devices 765 (interfaced with a USB controller 770), and a storage interface 780. Also included are at least one sensor 755 connected to bus 705 through a sensor controller 760 and a network interface 785 (coupled directly to bus 705).

The bus 705 may allow data communication between the central processor 710 and the system memory 715, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components or devices. For example, an staff management module 110-b to implement the present systems and methods may be stored within the system memory 715. Applications (e.g., application 230) resident with the computer system 700 are generally stored on and accessed via a non-transitory computer readable medium, such as a hard disk drive (e.g., fixed disk drive 775) or other storage medium. Additionally, applications can be in the form of electronic signals modulated in accordance with the application and data communication technology when accessed via the network interface 785.

The storage interface 780, as with the other storage interfaces of the computer system 700, can connect to a standard computer readable medium for storage and/or retrieval of information, such as a fixed disk drive 775. The fixed disk drive 775 may be a part of the computer system 700 or may be separate and accessed through other interface systems. The network interface 785 may provide a direct connection to a remote server via a direct network link to the Internet via a POP (point of presence). The network interface 785 may provide such connection using wireless techniques, including digital cellular telephone connection, Cellular Digital Packet Data (CDPD) connection, digital satellite data connection, or the like.

Many other devices or subsystems (not shown) may be connected in a similar manner (e.g., documents scanners, digital cameras, and so on). Conversely, all of the devices shown in FIG. 7 need not be present to practice the present systems and methods. The devices and subsystems can be interconnected in different ways from that shown in FIG. 7. The aspect of some operations of a system such as that shown in FIG. 7 are readily known in the art and are not discussed in detail in this application. Code to implement the present disclosure can be stored in a non-transitory computer-readable medium such as one or more of system memory 715 or fixed disk drive 775. The operating system provided on the computer system 700 may be iOS® ANDROID®, MS-DOS®, MS-WINDOWS®, OS/2® UNIX®, LINUX® or another known operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present systems and methods may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Furthermore, while various embodiments have been described and/or illustrated herein in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.” In addition, the term “based on” as used in the specification and the claims is to be construed as meaning “based at least upon.”

What is claimed is:

1. A computer-implemented method to manage staffing requirements, comprising:
creating a network of employees;
determining if a staffing level from the network of employees satisfies a threshold; and
polling one or more employees from the network of employees based at least in part on the determining.

2. The computer-implemented method of claim 1, wherein creating a network of employees comprises:
registering a Global Positioning System (GPS) enabled device associated with each employee of the network of employees; and
adding the GPS-enabled device to a network associated with an employer.

3. The computer-implemented method of claim 2, wherein the GPS-enabled device comprises a profile including available work times, primary job duties, and secondary job duties.

4. The computer-implemented method of claim 1, wherein determining if a staffing level satisfies a threshold occurs on a regularly scheduled basis.

5. The computer-implemented method of claim 4, wherein determining if a staffing level satisfies a threshold occurs on an hourly basis.

6. The computer-implemented method of claim 1, further comprising:
determining a necessary staffing level requirement, wherein the requirement consists of a combination of number of employees and job function of the employees.

7. The computer-implemented method of claim 1, wherein determining if the staffing level satisfies the threshold comprises:
comparing the staffing level to a necessary staffing level requirement to determine if the staffing level satisfies the threshold, wherein the staffing level is based at least in part on a number of employees and job functions of the employees.

8. The computer-implemented method of claim 1, further comprising:
predicting a potential staffing shortage.

9. The computer-implemented method of claim 8, wherein predicting a potential staffing shortage comprises:
identifying a physical location of a scheduled employee prior to a scheduled shift; and
determining the identified physical location of the scheduled employee is greater than a distance threshold.

10. The computer-implemented method of claim 1, wherein polling one or more employees from the network of employees comprises:
identifying a first employee;
sending a message to a Global Positioning System (GPS) enabled device associated with the first employee; and
receiving a response from the first employee.

11. The computer-implemented method of claim 10, wherein identifying the first employee comprises:
identifying a current location of the first employee; and
identifying one or more primary job duties or secondary job duties associated with the first employee.

12. The computer implemented method of claim 10, wherein upon receiving a negative response from the first employee, the method comprises:
identifying a second employee, wherein identifying the second employee is based at least in part on a current location of the second employee and one or more primary job duties or secondary job duties of the second employee; and
sending a message to the second employee.

13. The computer-implemented method of claim 12, wherein the negative response comprises a non-receipt of a response within a predetermined time period.

14. An apparatus for managing staffing requirements, comprising:
a processor;
a memory in electronic communication with the processor; and
instructions stored in the memory, the instructions being executable by the processor to:
create a network of employees;
determine if a staffing level from the network of employees satisfies a threshold; and
poll one or more employees from the network of employees based at least in part on the determination.

15. The apparatus of claim 14, wherein to create a network of employees, the instructions are executable by the processor to:
register a Global Positioning System (GPS) enabled device associated with each employee of the network of employees; and
add the GPS-enabled device to a network associated with an employer.

16. The apparatus of claim 15, wherein the GPS-enabled device comprises a profile including available work times, primary job duties, and secondary job duties.

17. The apparatus of claim 14, wherein the instructions are executable by the processor to:
determine a necessary staffing level requirement, wherein the requirement consists of a combination of number of employees and job function of the employees.

18. A computer-program product for managing staffing requirements, the computer-program product comprising a non-transitory computer-readable medium storing instructions executable by a processor to:
create a network of employees;
determine if a staffing level from the network of employees satisfies a threshold; and
poll one or more employees from the network of employees based at least in part on the determination.

19. The computer-program product of claim 18, wherein to create a network of employees, the instructions are executable by the processor to:
register a Global Positioning System (GPS) enabled device associated with each employee of the network of employees; and
add the GPS-enabled device to a network associated with an employer.

20. The computer-program product of claim 18, wherein the instructions are executable by the processor to:
determine a necessary staffing level requirement, wherein the requirement consists of a combination of number of employees and job function of the employees.
